(19) United States
(12) Patent Application Publication
(10) Pub. No.: US 2006/0085659 A1
(43) Pub. Date: Apr. 20, 2006

(54) Power saving method for portable information processing unit, and portable information processing system

(75) Inventors: Yoshio Nishinaga, Kawasaki (JP); Yoshitomo Ishii, Kawasaki (JP); Minoru Maeda, Kawasaki (JP); Yoshiaki Kikuchi, Kawasaki (JP); Tohru Ida, Kawasaki (JP); Masami Eto, Kawasaki (JP); Kimihiro Sawada, Kawasaki (JP); Masahiro Nakajima, Kawasaki (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/296,380

(22) Filed: Dec. 8, 2005

Related U.S. Application Data
(63) Continuation of application No. PCT/JP03/07533, filed on Jun. 13, 2003.

(51) Int. Cl. G06F 1/32

(52) U.S. Cl. 713/320

(57) ABSTRACT

A system realize power saving of a portable information processing unit including an external device, when the external unit receiving the power supplied from the portable information processing unit is connected to the portable information processing unit. An operation mode according to the power supply state of the external unit is set into the portable information processing unit, and the external device is informed of the set operation mode, according to the power supply state. When data processing is in execution also in the external device upon request from the portable information processing unit, even when the operation mode change information is received, the mode change is awaited until the completion of the processing of the external device. Thus, by changing the operation mode, low-power consumption operation including the external device can be realized without impeding the operation in the external device.

### CROSS-REFERENCE TO RELATED APPLICATIONS

This application is a continuation of international application PCT/JP2003/007533, filed on Jun. 13, 2003.

### FIELD OF THE INVENTION

The present invention relates to a power saving method for a portable information processing unit such as a notebook personal computer when an external unit is connected thereto, and a portable information processing system, and more particularly, a power saving method for a portable information processing unit saving the power according to a use state by a user, and a portable information processing system.

### BACKGROUND OF THE INVENTION

In recent years, use of a portable information terminal such as a notebook personal computer (PC) and a personal digital assistant (PDA) has been spreading, and there is an increased requirement for data communication (electronic mail and Internet connection) performed in a place where an AC power supply is hard to obtain.

In the portable information processing unit such as the notebook personal computer and the PDA, a product having as much battery life as bearable for ordinary use while a user is out has been developed, resulting from efforts to reduce power consumption in the portable information processing unit, and to improve battery capacity as well.

Further, for example, a notebook personal computer installing Windows OS (product name) from Microsoft Corporation is provided with a mechanism for changing a CPU operating clock and luminance of the display unit depending on a power supply state (AC power feed or battery), thereby leaving a user to set a balance between the performance and the battery life.

While, there is a case of connecting the mobile information terminal to an external device. For, example, in the case of communicating by using the mobile information terminal, especially a wireless communication, the external device that is necessary for the communication is connected to the mobile information terminal. A power consumption amount of the external device is not small, so it is necessary to perform power save the total device including the external device.

Conventionally, in the external devices connected to the information terminal, there has been proposed a method for switching an operation mode from a normal mode to a power save mode depending on the type of the power supplied, and the supplied power (for example, Japanese Unexamined Patent Publication No. 2001-148173 or the Japanese Unexamined Patent Publication No. 2002-3672).

However, according to the conventional power saving method, because the external devices itself such as a hard disk unit and a printer are automatically changed to a power save mode according to the type of power and a power level, a situation undesirable to an information terminal user may possibly occur. For example, though the user wants the normal mode, the mode is automatically changed to a low-speed mode, producing a longer processing time, while a longer continuation time is obtained. In particular, when a mobile communication terminal is used as an external device, a communication time is elongated because of the low-speed mode, though the user wants to communicate immediately.

Also, when the external device has no decision function on a mode change, and is changed to the power save mode triggered by an instruction from the portable information terminal, the processing in the external device may be confused. For example, in the mobile communication terminal, when the instruction to change to the power save mode is received while data is being received through a network, and thereby the reception mode is changed to low speed, it becomes unable to receive data correctly.

### SUMMARY OF THE INVENTION

Accordingly, it is an object of the present invention to provide a power saving method for a portable information processing unit, and to provide a portable information processing system, capable of selecting a power save mode or a normal mode depending on a use state of a user, and for performing power saving without interfering with the operation of an external device.

It is another object of the present invention to provide a power saving method for a portable information processing unit, and to provide a portable information processing system, in a portable information processing unit in which an external device connected thereto communicates with another device, so as to prevent communication operation of the external unit from being impeded even when a power save mode is instructed through automatically supervising the power supply in the unit.

It is still another object of the present invention to provide a power saving method for a portable information processing unit, and to provide a portable information processing system, capable of selecting a power save mode or a normal mode depending on a use state of a user, and for changing an operation mode without interfering with the operation of an external device.

In order to achieve the aforementioned objects, according to the present invention, in a power saving method for a portable information processing unit which connects an external device operated by the power supplied from the portable information processing unit, and operates the external device in a low-power consumption mode, the method includes a step of detecting a power supply state of the portable information processing unit; a step of informing the external device of the operation mode in the external device, being set from between a normal operation mode and a low-power consumption operation mode according to the power supply state; a step of comparing a present operation mode with the informed operation mode in the external device; and a step of changing in the external device the operation mode to the informed operation mode after completion of the processing being in execution in the external device when the present operation mode is different from the informed operation mode.

Further, according to the present invention, a portable information processing system includes a portable information processing unit, and an external device operated by the power supplied from the portable information processing unit. The portable information processing unit further includes: a power supply state supervision section for detecting a power supply state of the unit; and a processing unit for informing the external device of the operation mode in the external device, being set from between a normal operation mode and a low-power consumption operation mode according to the power supply state. The external device includes a processing unit that compares a present operation mode of the external device with the informed operation mode, and when the present operation mode is different from the informed operation mode, changes the operation mode to the informed operation mode after completion of the processing being in execution in the external device.

According to the present invention, when the external device receiving the power supplied from the portable information processing unit is connected to the portable information processing unit, an operation mode according to the power supply state of the external device is set into the portable information processing unit. Therefore, it becomes possible to select the operation mode of the external device according to the power supply state depending on a preference of the user.

Further, also the external device, when data processing is in execution upon request from a portable information terminal, await the change of the operation mode until completion of the processing even when operation mode change information is received. Accordingly, it becomes possible to realize low power consumption operation including the external device by changing the operation mode, without impeding the operation in the external device.

Further, according to the present invention, preferably, the method further includes a step for setting to the portable information processing unit an operation mode from between the normal operation mode and the low-power consumption operation mode, according to the power supply state. With this, the user can set or change the operation mode according to the power supply state arbitrarily at a required time point.

Further, according to the present invention, preferably, the step for detecting the power supply state includes a step for detecting whether the power supply of the portable information processing unit is an AC power supply or a battery supply. With this, it becomes possible to realize power saving in the portable information processing unit to which both AC power and battery can be supplied, at the time of battery operation.

Further, according to the present invention, preferably, the step for detecting the power supply state includes a step for detecting a remaining battery capacity, which is a power supply to the portable information processing unit. With this, power saving can be achieved even when the portable information processing unit is battery operated, making it possible to guarantee long time operation.

Further, according to the present invention, preferably, the external device is a communication terminal of the portable information processing unit, and the operation mode includes a normal operation mode having a relatively high communication speed, and a low-power consumption operation mode having a relatively low communication speed. With this, it becomes possible to realize power saving including the external device, without impeding communication terminal operation, i.e. communication in the portable information processing unit.

Further, according to the present invention, preferably, the external device is a card-type communication terminal to be inserted into a slot of the portable information processing unit. With this, data communication by a lightweight information processing unit used while a user is out can be realized preventing the user from being anxious about power consumption.

### BRIEF DESCRIPTION OF THE DRAWINGS

FIG. 1 shows an outer view of a portable information processing unit according to one embodiment of the present invention,

FIG. 2 shows an internal circuit block diagram of the unit shown in FIG. 1,

FIG. 3 shows a flow diagram of operation mode change processing in the portable information processing unit shown in FIG. 2,

FIG. 4 shows an explanation diagram of a screen for setting an operation mode of an external device shown in FIG. 3,

FIG. 5 shows a flow diagram of operation mode change processing in the external device shown in FIG. 2,

FIG. 6 shows a flow diagram of operation mode execution processing in the external device shown in FIG. 2,

FIG. 7 shows an explanation diagram of the operation mode shown in FIG. 6, and

FIG. 8 shows an explanation diagram of operation mode setting according to another embodiment of the present invention.

### PREFERRED EMBODIMENTS OF THE INVENTION

The embodiments of the present invention are described hereinafter in the order of portable information processing unit, operation mode change processing, and other embodiments.

Portable Information Processing Unit:

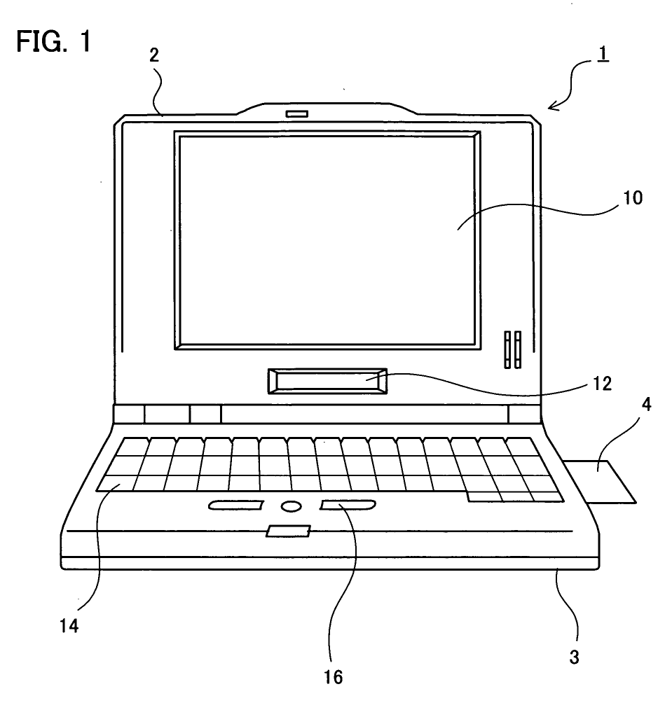

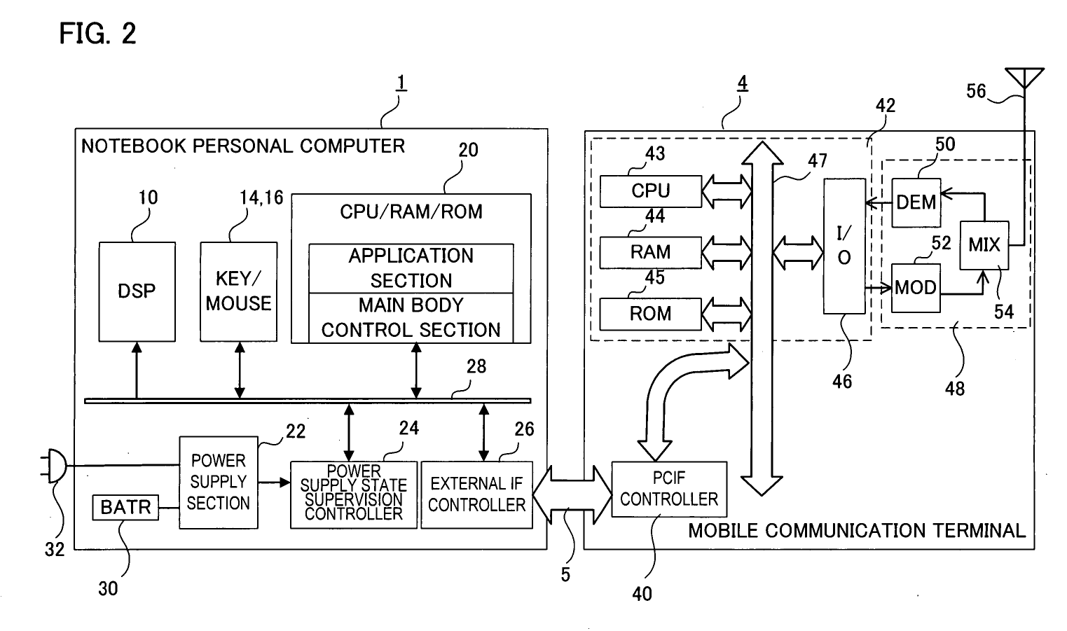

FIG. 1 shows an outer view of a portable information processing unit according to one embodiment of the present invention. FIG. 2 shows an internal block diagram of the configuration shown in FIG. 1. By way of example, in FIG. 1, a notebook personal computer 1 is shown as portable information processing unit, while a card-type data communication terminal 4 to be inserted to a slot of the above unit is shown as external device.

As shown in FIG. 1, the notebook personal computer 1 includes a base 3, and a cover 2 foldable to the base 3. FIG. 1 illustrates a state that the cover 2 of the notebook personal computer 1 is open. On the cover 2, a display unit 10 constituted of liquid crystal panel or the like and a sub-display unit 12 for state indication, etc. are provided.

Meanwhile, on the surface of the base 2, a keyboard 14 and a flat mouse/pointer 16 are disposed, as well as a variety of circuits as shown in FIG. 2 internally. A card-type data communication terminal (wireless card) 4 is inserted into a PC card slot disposed on a side face of the base 3.

As shown in FIG. 2, the notebook personal computer 1 includes a processing unit 20 having CPU, RAM and ROM, the above-mentioned display 10 and keyboard/mouse 14, 16, a power supply unit 22 having an AC power supply socket 32 and a battery 30, a power supply state supervision circuit 24 for supervising the power supply state of the power supply unit 22, an external interface control circuit 26 for conforming to the PCMCIA (Personal Computer Memory Card International Association) standard, and a bus 28 for connecting the above units and circuits.

Meanwhile, the card-type data communication terminal 4 includes a PC interface control circuit 40 conforming to the PCMCIA standard, a control unit 42 connected to the PC interface control circuit 40, and a radio circuit 48 connected to the control unit 42.

The control unit 42 is constituted of CPU 43, RAM 44, ROM 45, I/O port 46, and a bus 47 for connecting the above units with the PC interface control circuit 40. The radio circuit 48 includes a modulation circuit 52, a demodulation circuit 50, a multiplexing/demultiplexing circuit 54, and an antenna 56, so as to perform wireless communication corresponding to W-CDMA, such as FOMA (Freedom of Mobile Multimedia Access; service name of NTT Docomo). Also, wireless systems corresponding to CDMA, PHS, etc. may be applicable.

The notebook personal computer 1 and the card-type data communication terminal 4 are connected through the PCMCIA standard interface 5, and power is supplied from the notebook personal computer 1 to the card-type data communication terminal 4. Also, the operating clock and the communication speed of the card-type data terminal 4 can be changed under the control of the CPU 43. For example, either 50 MHz or 25 MHz is selectable as operating clock, and either 384 kbps or 64 kbps is selectable as communication speed.

Operation Mode Change Processing:

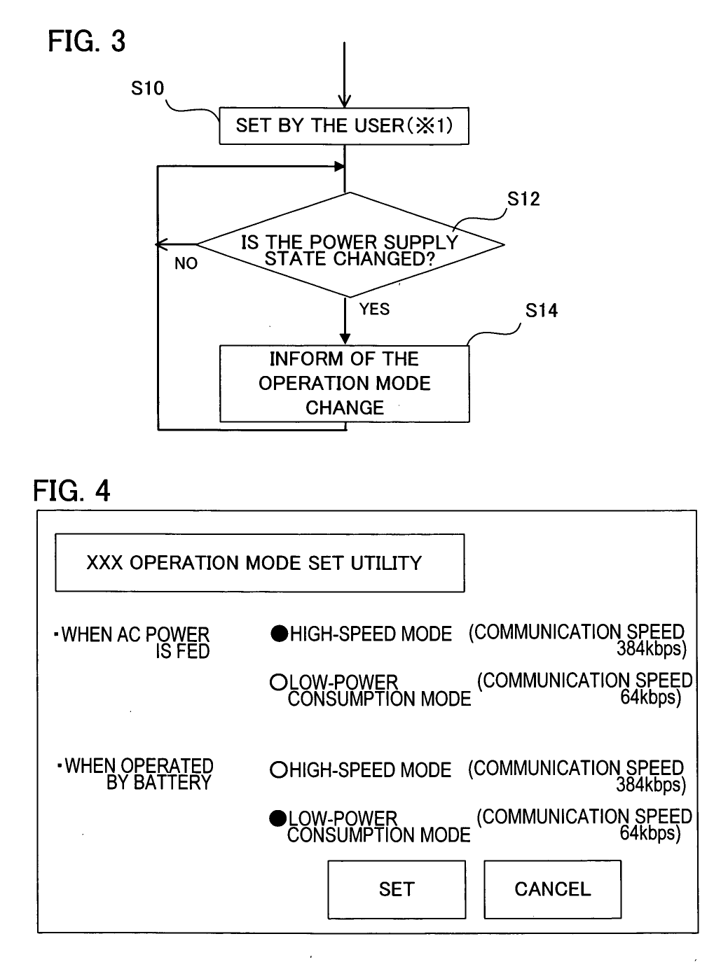

Next, operation mode change processing performing power saving according to a power supply state will be described. FIGS. 3 to 7 show explanation diagrams of the operation mode change processing in case of performing data communication by connecting the notebook personal computer 1, having the power supply state supervision circuit 24 and the external device interface control circuit 26, with the mobile communication terminal 4 having a data communication function. FIG. 3 shows a flow diagram of operation mode change processing in the notebook type personal computer 1 shown in FIG. 2. FIG. 4 shows an explanation diagram of a user set screen thereof.

(S10) In order to set the operation mode, an operation mode set utility shown in FIG. 4 is called, so as to display a set screen on the display 10. Through the above set screen, it is possible to set the mode at the time of an AC power supply either to a high-speed mode (communication speed of 384 kbps) or a low-power consumption mode (communication speed of 64 kbps), and also the mode at the time of battery operation either to the high-speed mode (communication speed of 384 kbps) or the low-power consumption mode (communication speed of 64 kbps), using the mouse, etc.

The CPU 20 stores the operation mode which is set according to the power supply state. In the example shown in FIG. 4, there is shown an example of setting to the high-speed mode (communication speed of 384 kbps) at the time of the AC power supply, and setting to the low-power consumption mode (communication speed of 64 kbps) at the time of battery operation.

(S12) The power supply state supervision circuit 24 supervises the power supply state (AC power supply or battery) of the personal computer 1, and informs the main body control section in the CPU 20 on detecting that the power supply state is changed.

(S14) As shown in FIG. 4, the CPU 20 calls the power supply state/operation mode being set by the user beforehand, and informs the mobile communication terminal 4 of the above operation mode through the external interface control circuit 26, and then returns to the step S12.

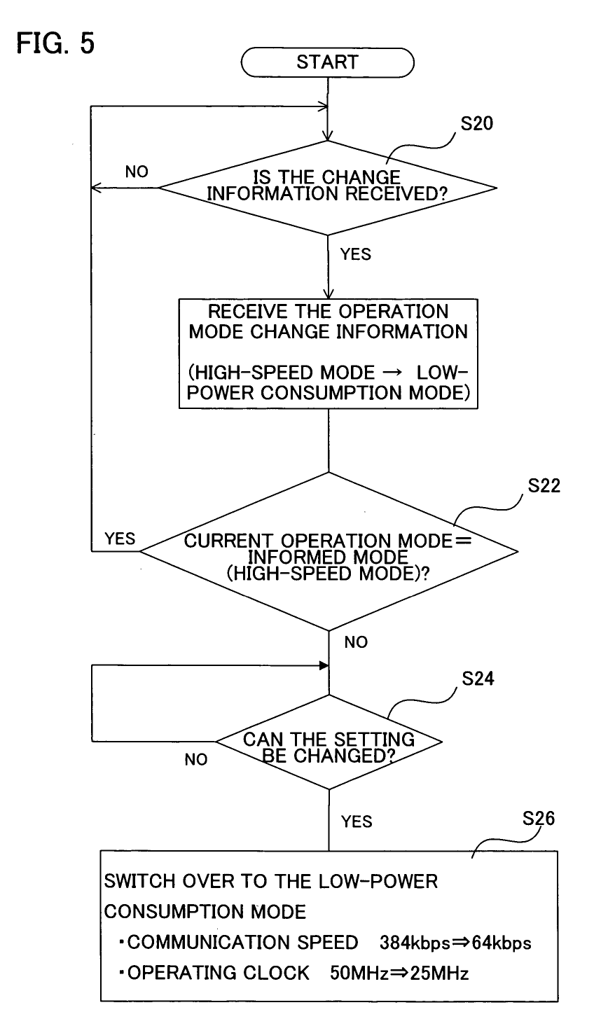

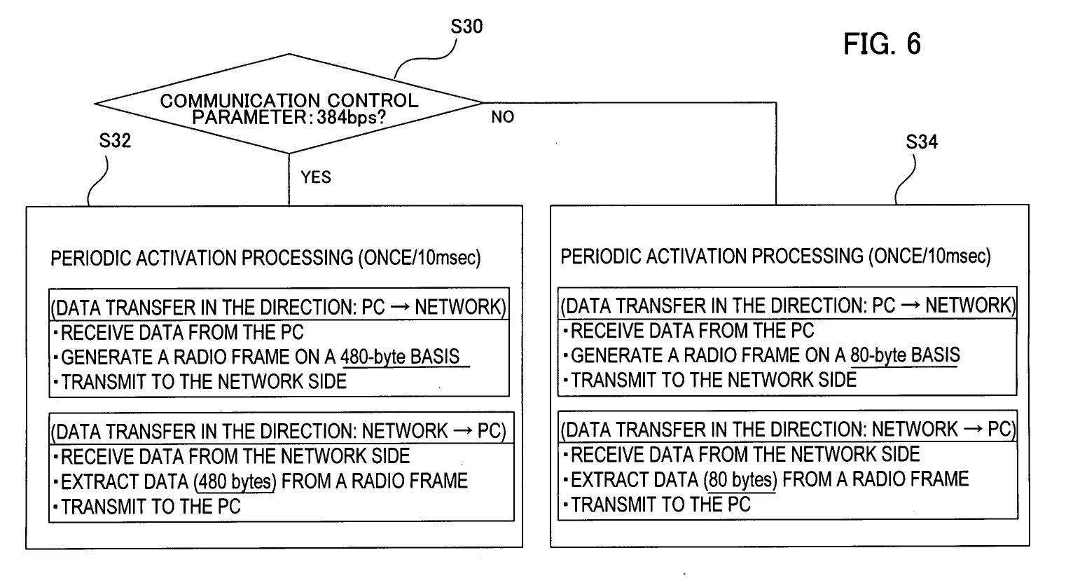

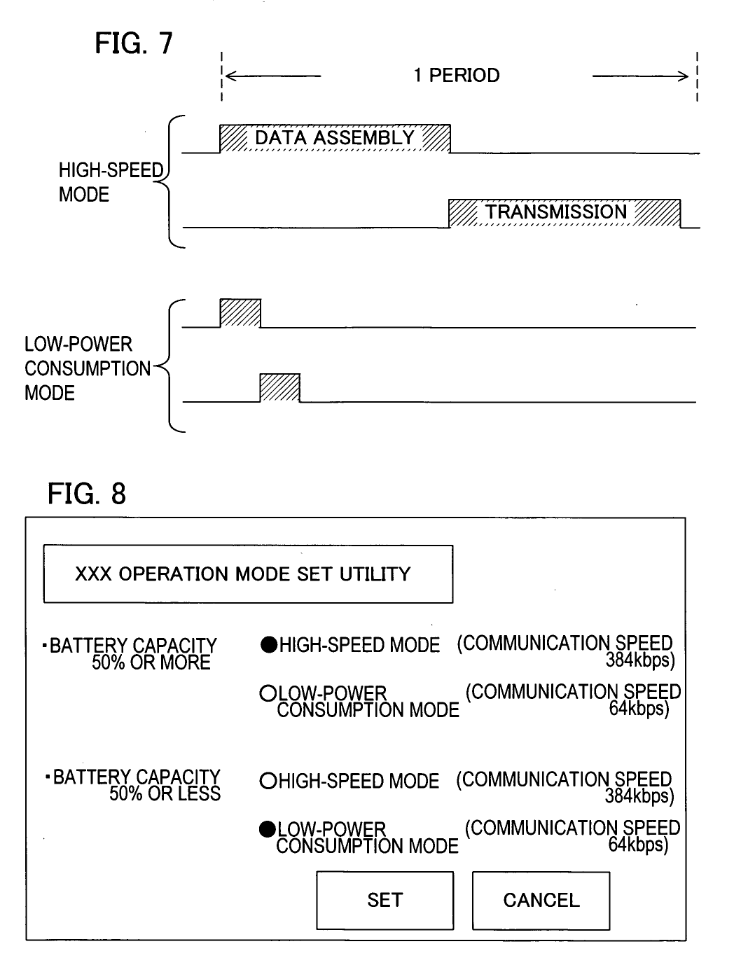

Next, the operation mode change processing in the mobile communication terminal (card-type data communication terminal) will be explained, using FIGS. 5 to 7. FIG. 5 shows a flow diagram of operation mode change processing in the card-type data communication terminal. Also, FIG. 6 shows a flow diagram of communication processing therein, and FIG. 7 shows an explanation diagram of the communication operation.

(S20) The CPU 43 in the processing unit 42 of the terminal 4 decides whether the PC interface control circuit 40 receives the operation mode change information from the external interface control circuit 26 provided in the personal computer 1.

(S22) When the PC interface control circuit 40 receives the operation mode change information, the CPU 43 reads out the received information, and compares the present operation mode stored in the RAM 44 with the informed operation mode. When the both operation modes match, the CPU 43 does not change the operation mode, and returns to the step S20.

(S24) When the both operation modes do not match, the CPU 43 decides whether or not the operation mode setting can be changed. Namely, the CPU 43 decides whether or not communication is in execution using the radio circuit 48. Here, in the wireless communication, data from the personal computer 1 is stored in the RAM 44, and modulated in a modulation circuit 52 according to a communication speed, so as to perform radio transmission. Also, receiving signal received by an antenna 56 is demodulated in a demodulation circuit 50 according to the communication speed, stored into the RAM 44, and thereafter transmitted to the personal computer 1. When the operation mode setting cannot be changed (communication in progress), the operation mode setting is awaited until the setting can be changed (that is, communication completion).

(S26) When the CPU 43 decides that it becomes possible to change the setting, the CPU 43 changes the operation mode in the RAM 44. With this, the operation mode is changed. For example, when switching to the low-power consumption mode, the communication speed setting is changed from 384 kbps to 64 kbps, and the operating clock setting is changed from 50 MHz to 25 MHz.

Next, communication processing of the communication terminal 4 accompanying the above setting change will be explained using FIG. 6.

(S30) When starting communication, the CPU 43 reads out the operation mode in the RAM 44, and decides whether or not a communication control parameter is 384 kbps.

(S32) When the communication control parameter is 384 kbps, the CPU 34 performs the following processing. Namely, at the activation intervals of 10 msec, as to data transfer from the personal computer 1 to a network, a data is received from the personal computer 1, a radio frame is generated from the data on a basis of 480 bytes, and then the frame is transmitted to the network through the modulation circuit 52, the multiplexing/de-multiplexing circuit 54 and the antenna 56. Reversely, as to data transfer from the network to the personal computer 1, a radio frame is received from the network through the antenna 56, the multiplexing/de-multiplexing circuit 54 and the demodulation circuit 50, a data is extracted from the radio frame on a basis of 480 bytes, and then the data is transmitted to the personal computer 1 through the PC interface control circuit 40.

(S34) When the communication control parameter does not specify 384 kbps (i.e. specifies the low-power consumption mode of 64 kbps), the CPU 43 performs the following processing at activation intervals of 10 msec. Namely, as to data transfer from the personal computer 1 to the network, a data is received from the personal computer 1, a radio frame is generated from the data on a basis of 80 bytes, and then the frame is transmitted to the network through the modulation circuit 52, the multiplexing/demultiplexing circuit 54 and the antenna 56. Reversely, as to data transfer from the network to the personal computer 1, a radio frame is received from the network through the antenna 56, the multiplexing/demultiplexing circuit 54 and the demodulation circuit 50, a data is extracted from the radio frame on a basis of 80 bytes, and then the data is transmitted to the personal computer 1 through the PC interface control circuit 40.

FIG. 7 shows operation per unit time in the high-speed mode (384 kbps) and the low-power consumption mode (64 kbps) shown in FIG. 6. In transmission, the CPU 43 performs data assembly (radio frame generation) and transmission control. Here, the amount of software processing per unit time in the high-speed mode is different from the amount of the software processing per unit time in the low-power consumption mode. It becomes possible to reduce the power consumption by reducing the data communication speed.

As such, according to the present invention, in the case that an external unit which receives the power supplied from a portable information processing unit is connected to the portable information processing unit, an operation mode according to the power supply state of the external unit is set to the portable information processing unit. Accordingly, it becomes possible to select the operation mode of the external unit based on the power supply state according to a preference of the user.

For example, as described above, when the mode at the time of the AC power supply is set to the high-speed mode (communication speed of 384 kbps), and the mode at the time of battery operation is set to the low-power consumption mode (communication speed of 64 kbps), the external device can be operated in the low-power consumption mode at the time of the battery operation. Thus, it becomes possible to realize low-power consumption operation not only in the portable information processing unit, but including the external device. Namely, by suppressing useless power consumption, it becomes possible to contribute to the convenience of the user.

Meanwhile, when the mode at the time of the AC power supply is set to the high-speed mode (communication speed of 384 kbps), and the mode at the time of battery operation is also set to the high-speed mode (communication speed of 384 kbps), the external device can be operated in the high-speed mode even at the time of battery operation, which is effective when it is desired to perform the processing (for example, communication time) in the external device faster.

Also, when data processing is in execution in the external device upon request from the portable information terminal, the change of the operation mode is awaited until completion of the processing even when the operation mode change information is received. Accordingly, by changing the operation mode, it becomes possible to realize the low-power consumption operation including the external device without impeding the operation in the external device.

### Other Embodiments

FIG. 8 shows an explanation diagram of another embodiment of the present invention, in which an operation mode set utility screen is shown. In this example, in the portable information terminal at the time of battery drive, or driven by battery only, the high-speed mode or the low-power consumption mode can be set depending on the remaining amount of the battery capacity.

With this, in the portable information terminal at the time of battery drive, or driven by battery only, it becomes possible to realize the low-power consumption operation including the external device, not only in the portable information terminal.

In the foregoing description, the present invention is described using the embodiments. However, a variety of variations of the present invention may be possible within the scope of the effect of the present invention. It is not intended to exclude such variations from the technical scope of the invention.

For example, as portable information processing unit, the notebook personal computer has been explained. However, the present invention is applicable to other portable electronic devices such as PDA. Also, as external device, although the card-type data communication terminal has been explained, other external devices of card type, etc. may be applied. Further, as operation mode, two types, i.e. the high-speed mode and the low-power consumption mode, have been explained. However, a plurality of operation modes may also be applied, for example, by providing an intermediate mode.

### INDUSTRIAL APPLICABILITY

According to the present invention, when an external unit receiving the power supplied from a portable information processing unit is connected to the portable information processing unit, an operation mode according to the power supply state of the external unit is set into the portable information processing unit. Accordingly, it becomes possible to select an operation mode of the external unit based on the power supply state according to a preference of the user.

Also, when data processing is in execution in the external device upon request from the portable information processing unit, the change of the operation mode is awaited until completion of the processing even when the operation mode change information is received. Thus, by changing the operation mode, it becomes possible to realize low-power consumption operation including the external device, without impeding the operation in the external device.

What is claimed is:

1. A power saving method for a portable information processing unit which connects an external device operated by the power supplied from the portable information processing unit, and operates the external device in a low-power consumption mode, said power saving method comprising:
a step of detecting a power supply state of the portable information processing unit;
a step of informing the external device of the operation mode in the external device, being set from between a normal operation mode and a low-power consumption operation mode according to the power supply state;
a step of comparing a present operation mode with the informed operation mode in the external device; and
a step of changing in the external device the operation mode to the informed operation mode, after completion of the processing being in execution in the external device when the present operation mode is different from the informed operation mode.

2. The power saving method for the portable information processing unit according to claim 1, further comprising:
a step for setting to the portable information processing unit an operation mode according to the power supply state from between the normal operation mode and the low-power consumption operation mode.

3. The power saving method for the portable information processing unit according to claim 1,
wherein the step for detecting the power supply state comprises a step for detecting whether the power supply of the portable information processing unit is an AC power supply or a battery supply.

4. The power saving method for the portable information processing unit according to claim 1,
wherein the step for detecting the power supply state comprises a step for detecting a remaining battery capacity, which is a power supply of the portable information processing unit.

5. The power saving method for the portable information processing unit according to claim 1,
wherein the external device is a communication terminal of the portable information processing unit, and
wherein the operation mode includes a normal operation mode having a relatively high communication speed, and a low-power consumption operation mode having a relatively low communication speed of the communication terminal.

6. The power saving method for the portable information processing unit according to claim 5,
wherein the external device is a card-type communication terminal to be inserted into a slot of the portable information processing unit.

7. A portable information processing system comprising:
a portable information processing unit; and
an external device operated by the power supplied from the portable information processing unit,
wherein said portable information processing unit comprising:
a power supply state supervision section for detecting a power supply state of the unit; and
a processing unit for informing the external device of the operation mode in the external device, being set from between a normal operation mode and a low-power consumption operation mode according to the power supply state,
and wherein said the external device comprising:
a processing unit which compares a present operation mode of the external device with the informed operation mode, and changes the operation mode to the informed operation mode after completion of the processing being in execution in the external device when the present operation mode is different from the informed operation mode.

8. The portable information processing system according to claim 7,
wherein the portable information processing unit further comprises a means for setting to the processing unit an operation mode according to the power supply state from between the normal operation mode and the low-power consumption operation mode.

9. The portable information processing system according to claim 7,
wherein the power supply state supervision section detects whether the power supply of the portable information processing unit is an AC power supply or a battery supply.

10. The portable information processing system according to claim 7,
wherein the power supply state supervision section detects the remaining battery capacity, which is a power supply of the portable information processing unit.

11. The portable information processing system according to claim 7,
wherein the external device is a communication terminal of the portable information processing unit, and
wherein the operation mode includes a normal operation mode having a relatively high communication speed, and a low-power consumption operation mode having a relatively low communication speed of the communication terminal.

12. The portable information processing system according to claim 11,
wherein the external device comprise a card-type communication terminal to be inserted into a slot of the portable information processing unit.
